(19) United States
(12) Patent Application Publication
(10) Pub. No.: US 2006/0059296 A1
(43) Pub. Date: Mar. 16, 2006

(54) Emulating small block size of flash memory

(75) Inventors: Avraham Meir, Rishon Lezion (IL); Amir Ronen, Ramat Hasharon (IL)

Correspondence Address: DR. MARK FRIEDMAN LTD.;C/o Bill Polkinghorn, 9003 Florin Way, Upper Marlboro, MD, 20772, US

(73) Assignee: M-SYSTEMS FLASH DISK PIONEERS, LTD.

(21) Appl. No.: 11/159,172

(22) Filed: Jun. 23, 2005

Related U.S. Application Data
(60) Provisional application No. 60/609,974, filed on Sep. 16, 2004.

(51) Int. Cl. G06F 12/00

(52) U.S. Cl. 711/103; 711/170

(57) ABSTRACT

A memory, that is erased in units of physical blocks, is presented as though the memory is erased in units of pseudo-blocks that are smaller than the physical blocks. One of the physical blocks is designated spare. In one embodiment, to erase a pseudo-block, all other valid data in the corresponding physical block are copied to the spare physical block, the target physical block is erased, and either the other valid data are copied back or the target physical block becomes the spare. In another embodiment, to erase a pseudo-block that is logically associated with a virtual block, the virtual block is marked as logically erased and the pseudo-block is logically associated with a blank virtual block. If necessary, a blank virtual block is created by swapping the spare with an appropriate other physical block.

This patent application claims the benefit of U.S. Provisional Patent Application No. 60/609,974, filed Sep. 16, 2004

### FIELD AND BACKGROUND OF THE INVENTION

The present invention relates to memories such as flash memories that are erased in blocks and, more particularly, to a method of accessing such a memory as though the physical size of an erase block were smaller than it really is.

Flash memory devices are capable of performing three basic operations: reading, writing (often called “programming” for historical reasons) and erasing. For many types of flash memory, for example NAND flash memories, both writing and erasing can only be done collectively on groups of memory cells, not on individual memory cells. These groups typically are relatively small for writing (typically 512 bytes or 2048 bytes at a time for NAND flash) but relatively large for erasing (typically 32 Kbytes or 128 Kbytes for NAND flash). The unit of cells of a memory that is erased together is called herein a “block”.

The recent trend in the flash memory industry has been to increase the size of erase blocks, in terms of number of bits per block. The reasons for this trend include:

a. A larger block means relatively less overhead in peripheral circuitry, hence less silicon area and lower cost per memory device for a given storage capacity.

b. In recent years, flash memory vendors have introduced to the market “multi-level cell” (MLC) devices that store more than one bit per cell, typically two bits per cell, as opposed to the single bit per cell storage of traditional “single-level cell” (SLC) devices. Storing two bits per cell doubles the size of an erase block in terms of data bits, even though the size of the erase block remains constant in terms of number of cells.

Changing the size of erase blocks creates backward compatibility problems. Consider a controller that manages a data base on a flash memory device. Such management includes occasional erase operations. If the flash device is replaced with a new device with a different block size, the flash management software typically does not work properly. For example, if the new block size is larger than the old block size that the management software was designed for, the controller could issue a command, intended to erase 32 Kbytes of data, that actually erases 128 Kbytes of data, thereby inadvertently deleting data that should not have been deleted.

In the case of the substitution of a flash memory device with a small block size for a flash memory device with a large block size, it is known to provide an intermediate layer of control between the flash device and the controlling software. The intermediate layer controls the flash device according to the device's actual block size while emulating a larger block size for the host of the device. See for example Lasser, U.S. Pat. No. 6,591,330. Such small-to-large emulation is relatively straightforward: the controlling software just assumes the large block size, erases the small blocks in groups, and ignores the option of erasing individual small blocks. Unfortunately, the prior art does not teach large-to-small emulation.

There is thus a widely recognized need for, and it would be highly advantageous to have, a method of managing a flash memory that has a large block size using software designed for a flash memory with a smaller block size.

### SUMMARY OF THE INVENTION

According to the present invention there is provided a method of managing a memory, including the steps of: (a) structuring the memory as a plurality of physical blocks having a certain size, the memory being erased in units of the physical blocks; and (b) presenting the memory as though the memory is erased in units of pseudo-blocks that are smaller in size than the physical blocks.

According to the present invention there is provided a memory device including: (a) a memory that includes a plurality of physical blocks having a certain size; and (b) a controller for: (i) erasing the memory in units of the physical blocks, and (ii) presenting the memory as though the memory is erased in units of pseudo-blocks that are smaller in size than the physical blocks.

According to the present invention there is provided a computer-readable storage medium having computer-readable code embedded on the computer-readable storage medium, the computer-readable code for managing a memory that includes a plurality of physical blocks having a certain size, the computer-readable code including: (a) program code for erasing the memory in units of the physical blocks; and (b) program code for presenting the memory as though the memory is erased in units of pseudo-blocks that are smaller in size than the physical blocks.

Most generally, the method of the present invention is a method of managing a memory that is structured as a plurality of physical blocks and that is erased in units of those physical blocks, one or more physical blocks at a time. The memory is presented as though the memory is erased in units of smaller groups of cells that are herein called “pseudo-blocks”. Typically, as is assumed in the examples presented below, the size of the physical blocks is an integral multiple of the size of the pseudo-blocks.

Three specific algorithms of the present invention are discussed below.

The first algorithm starts by designating one of the physical blocks as a spare physical block. Data are received from a host that expects the data to be stored in a physical block that is similar in size to a pseudo-block, and not in a physical block that is as large as the physical blocks of the memory really are. The data are stored in a physical block other than the spare physical block When a command is received to erase the data, all the valid contents of that other physical block, except for the data to be erased, are copied to the spare physical block. (“Valid” contents of memory cells are contents of memory cells that the host expects to read as valid data, as opposed to, e.g., the contents of memory cells that have not yet been written or the contents of memory cells that have been physically or logically erased.) The other physical block then is erased, the valid contents are copied back to that physical block, and the spare physical block is erased.

The second algorithm is similar to the first algorithm, except that instead of copying the valid contents back to the physical block in which the erased data had been stored, that physical block, having been erased, is substituted for the original spare physical block. The remaining valid data subsequently are accessed via the former spare physical block.

The third algorithm also starts by designating a first physical block as a spare physical block. The third algorithm also logically associates the pseudo-blocks, where the host thinks its data are being stored, with corresponding portions of other physical blocks that are equal in size to or slightly larger in size than the pseudo-blocks. These portions are called “virtual blocks” herein. When a command to erase a pseudo-block is received, the virtual block with which that pseudo-block is logically associated is marked as logically erased: the cells of the virtual block still contain the data that were stored therein, but that data is considered invalid. A different virtual block that is physically erased, and hence available for writing, now is sought. If such a virtual block is found, then the pseudo-block that is being erased is associated logically with that virtual block. Otherwise, data from one of the physical blocks other than the spare physical block are copied to the spare physical block. The physical block whose data are copied may be either the physical block that includes the virtual block with which the pseudo-block that is being erased initially was logically associated, or a different physical block. Only a portion of the physical block that is copied is copied to the spare physical block, in order to leave at least one of the virtual blocks of the spare physical block in a physically erased state. The pseudo-block that is being erased now is logically associated with one of the physically erased virtual blocks of the spare physical block. Finally, the physical block that has been partially copied to the spare physical block is erased and is substituted for the spare physical block.

The scope of the present invention also includes a memory device for implementing the method of the present invention and a computer-readable storage medium in which is embedded computer-readable code for implementing the method of the present invention. The memory device includes a memory with a plurality of physical blocks of a certain common size and a controller that erases the memory in units of those physical blocks but presents the memory as though the memory is erased in units of pseudo-blocks that are smaller in size than the physical blocks. Preferably, the memory is a flash memory.

### BRIEF DESCRIPTION OF THE DRAWINGS

The invention is herein described, by way of example only, with reference to the accompanying drawings, wherein:

FIG. 1 contrasts the actual physical structure of a memory with how the memory is presented to a host;

FIGS. 2A through 2E illustrate the first algorithm of the present invention;

FIGS. 3A through 3C illustrate the second algorithm of the present invention;

FIGS. 4A through 4E illustrate the third algorithm of the present invention;

FIG. 5 is a high-level block diagram of a flash memory device of the present invention;

FIG. 6 is a partial high-level block diagram of a computer system of the present invention.

### DESCRIPTION OF THE PREFERRED EMBODIMENTS

The present invention is of a method of managing a memory with relatively large erase blocks as though the memory had smaller erase blocks.

The principles and operation of memory management according to the present invention may be better understood with reference to the drawings and the accompanying description.

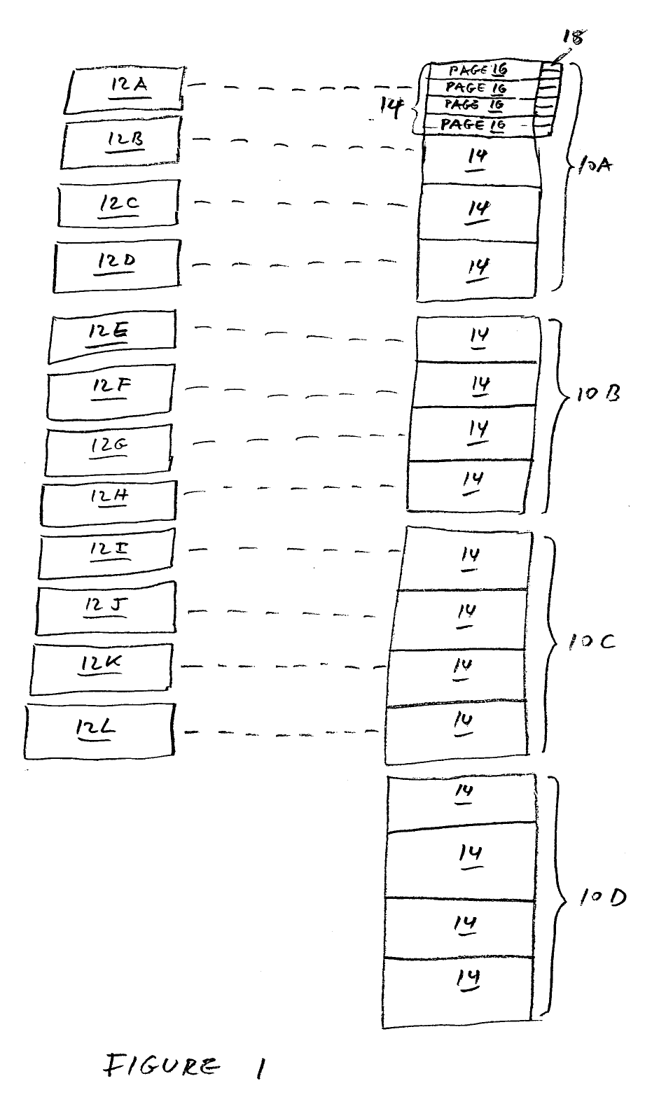

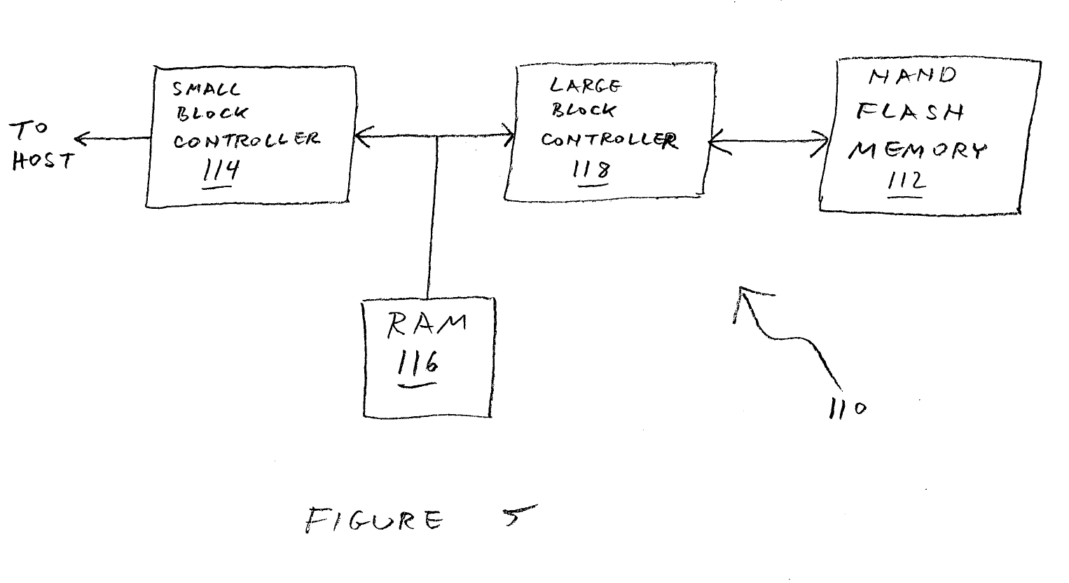

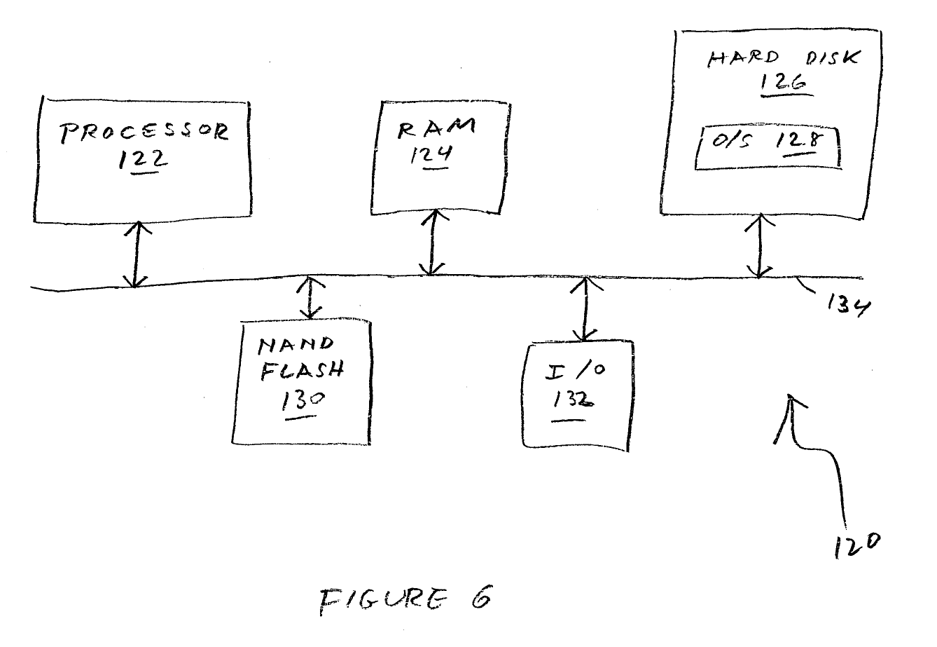

Referring now to the drawings, FIG. 1 contrasts the actual physical structure of a memory such as a NAND flash memory (on the right side of the Figure) with how the memory is presented to a host of the memory (on the left side of the Figure). This “host” could be, for example, a NAND flash memory controller that was originally intended for managing a NAND flash memory with a smaller erase block size (see FIG. 5 below) or a computer system whose operating system includes code for managing a NAND flash memory with a smaller erase block size (see FIG. 6 below). The memory includes a set of physical erase blocks 10, of which four, 10A through 10D, are shown in FIG. 1. In this particular example, each physical erase block 10 includes slightly more than 8K bytes. This is a small number, by modem standards, that is used here only for illustrative purposes.

In this particular example, the host of the memory expects a memory whose block size is 2K bytes. Therefore, the memory is presented to its host as a set of pseudo-blocks 12, of which twelve, 12A through 12L, are shown in FIG. 1. To each pseudo-block 12 corresponds a portion 14 (in this particular example, one quarter) of a physical block 10. The portion 14 of a physical block 10 that corresponds to a pseudo-block 12 is called herein a “virtual block”. The correspondence between virtual blocks 14 and pseudo-blocks 12 is indicated in FIG. 1 by dashed lines. This correspondence may be fixed (the same virtual block 14 always corresponds to the same pseudo-block 12) or variable (a pseudo-block 12 corresponds to different virtual blocks 14 at different times), but at any one time each virtual block 14 corresponds to at most one pseudo-block 12. In this particular example, as shown in FIG. 1 for the first virtual block 14 of physical block 10A, each virtual block 14 includes four pages 16 of 512 bytes each plus a small number of spare memory cells 18 that are used for bookkeeping purposes. The host directs read and write commands to corresponding 512-byte pages of pseudo-blocks 12 and directs erase commands to pseudo-blocks 12. A 512-byte page's worth of data that the host writes to a page of a pseudo-block 12 is actually written to a page 16 in the corresponding virtual block 14. The host is unaware of the spare memory cells 18.

Although for every pseudo-block 12 there must be a corresponding virtual block 14, there need not be a corresponding pseudo-block 12 for every virtual block 14. In particular, one physical block, at least initially physical block 10D in the examples below, always is reserved as a “spare” physical block that is in an erased state and whose virtual blocks 14 do not have corresponding pseudo-blocks 12.

### First Algorithm

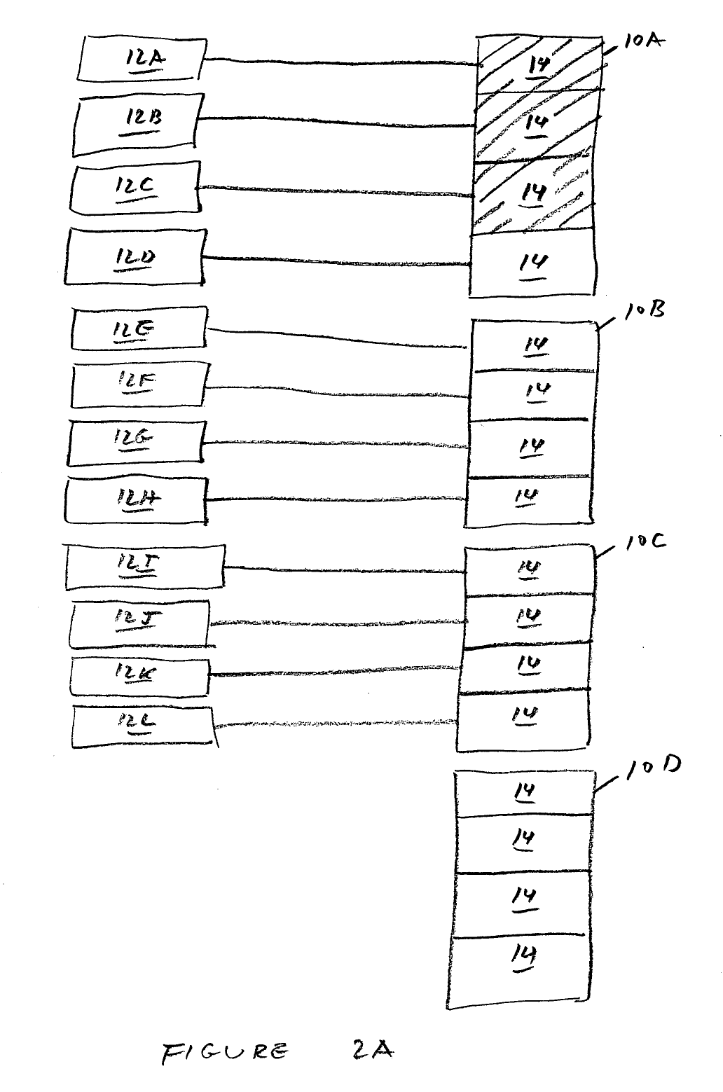

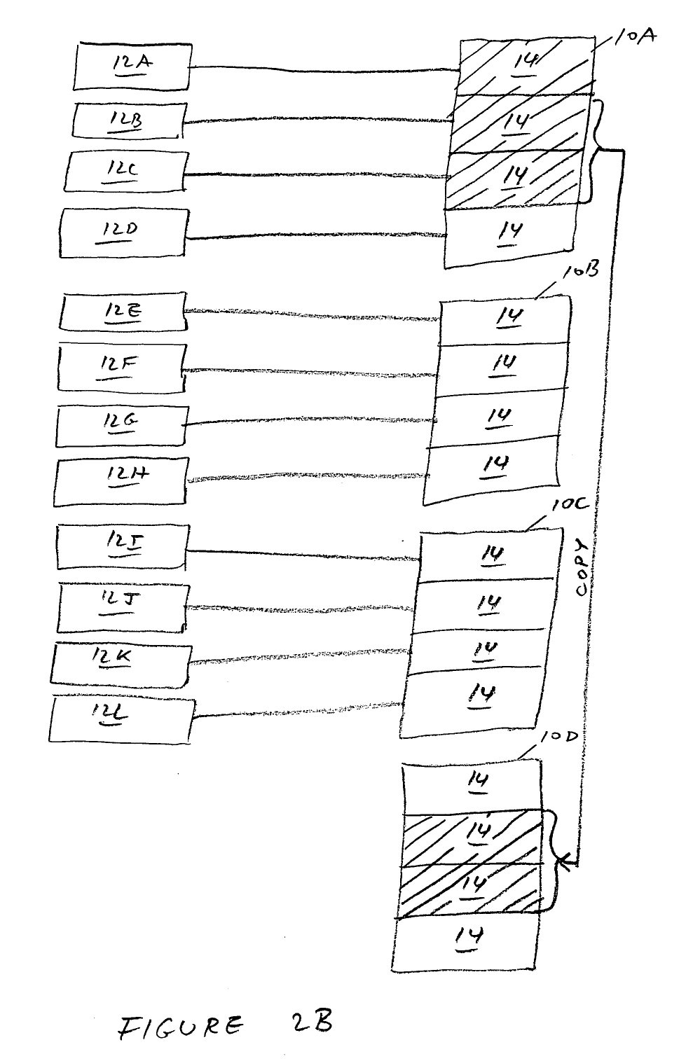

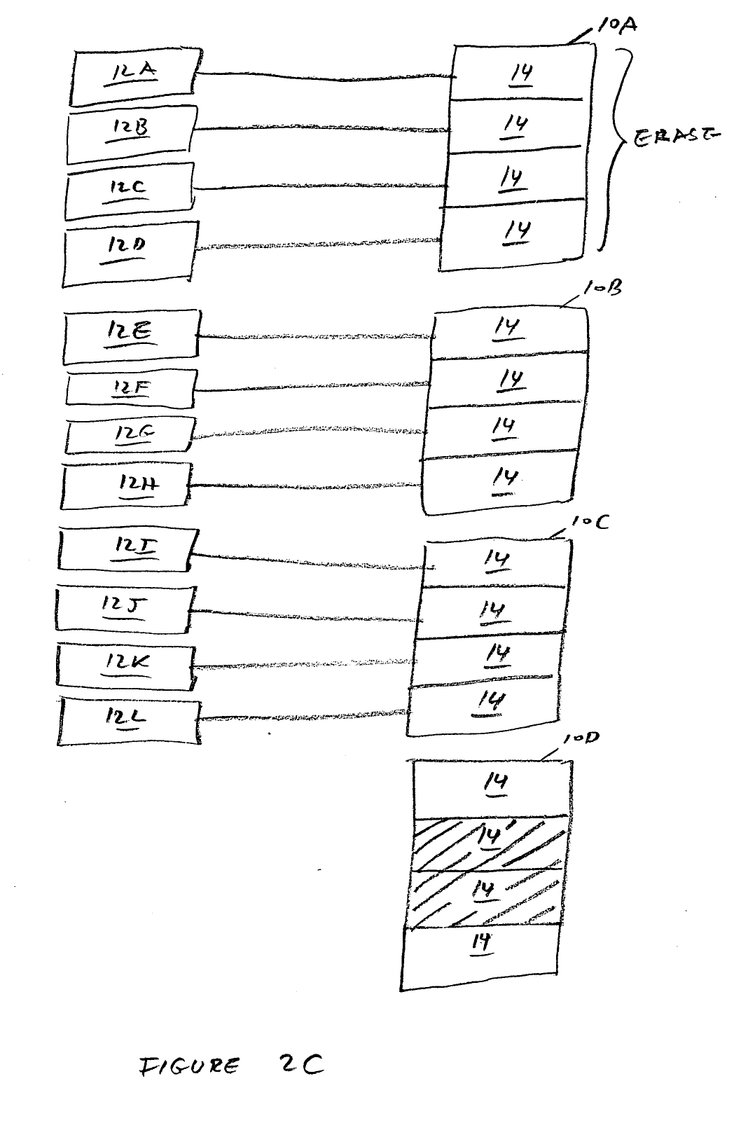

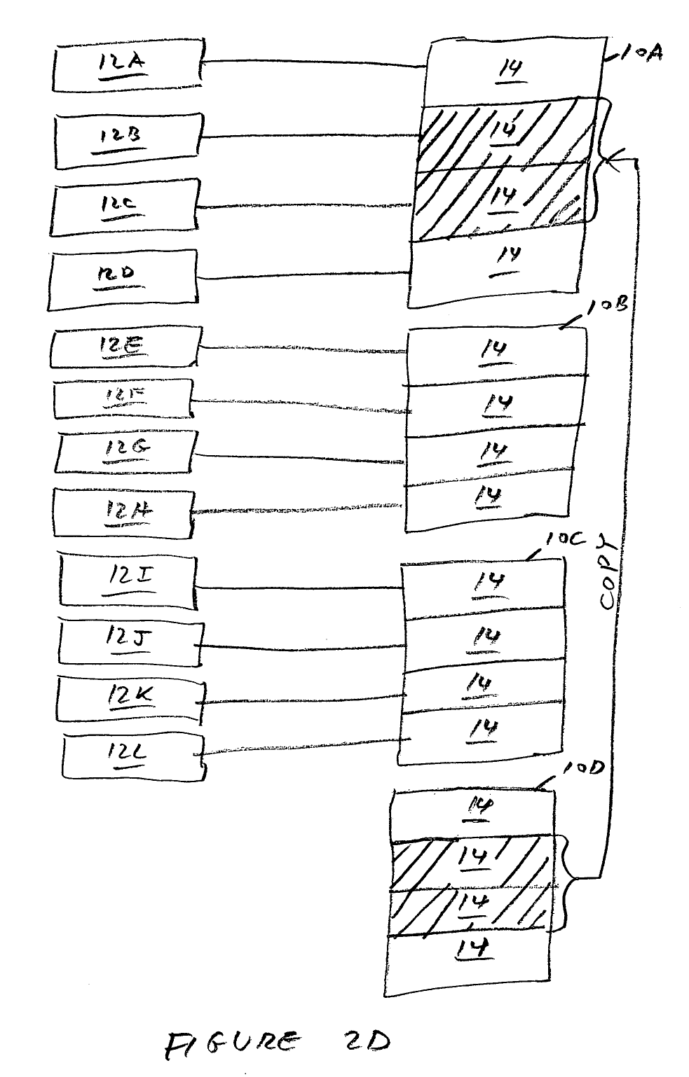

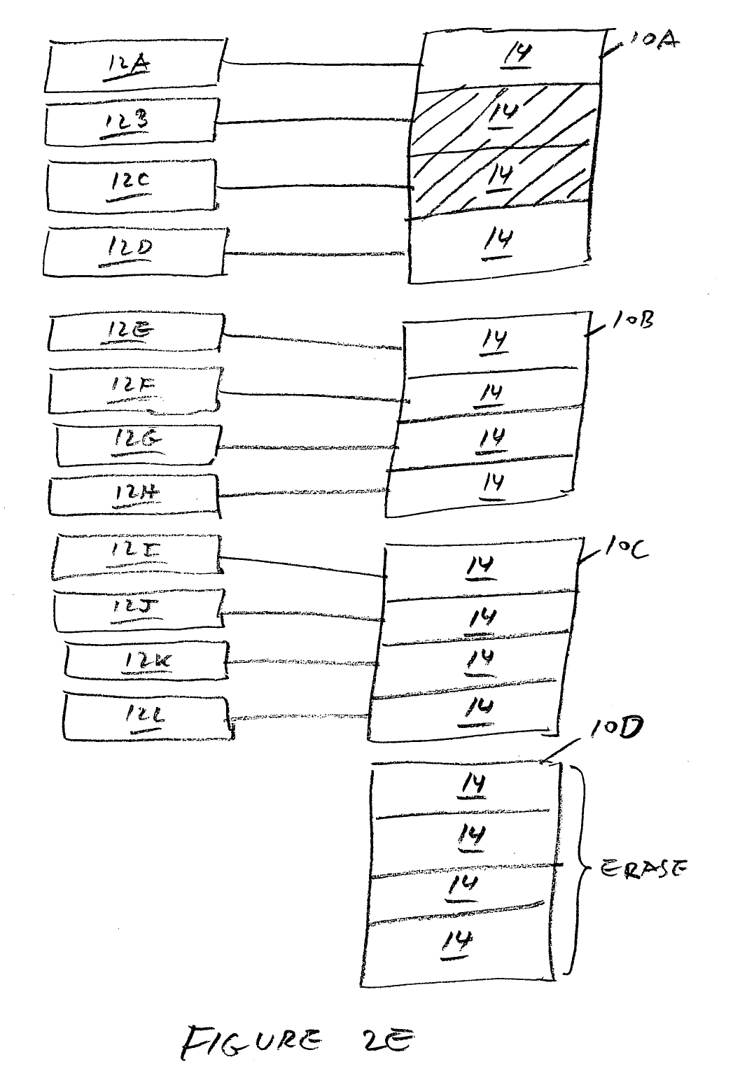

FIGS. 2A through 2E illustrate the first algorithm of the present invention. In this algorithm, the association of pseudo-blocks 12 with virtual blocks 14 is a fixed association, indicated in FIGS. 2A through 2E by solid lines.

FIG. 2A shows the initial condition of the memory, with valid data written to the virtual blocks 14 corresponding to pseudo-blocks 12A, 12B and 12C indicated by shading. The virtual block 14 that corresponds to pseudo-block 12D is blank.

The host issues a command to erase pseudo-block 12A. As shown in FIG. 2B, the other virtual blocks 14 of physical block 10A that contain valid data, i.e., the virtual blocks 14 that correspond to pseudo-blocks 12B and 12C, are copied to corresponding virtual blocks 14 in spare physical block 10D. The virtual block 14 that corresponds to pseudo-block 12D, being blank, is not copied. Then, physical block 10A is erased, as illustrated in FIG. 2C. Finally, the data that were copied to spare physical block 10D are restored to the virtual blocks 14 that correspond to pseudo-blocks 12B and 12C, as illustrated in FIG. 2D, and spare physical block 10D is erased, as illustrated in FIG. 2E.

### Second Algorithm

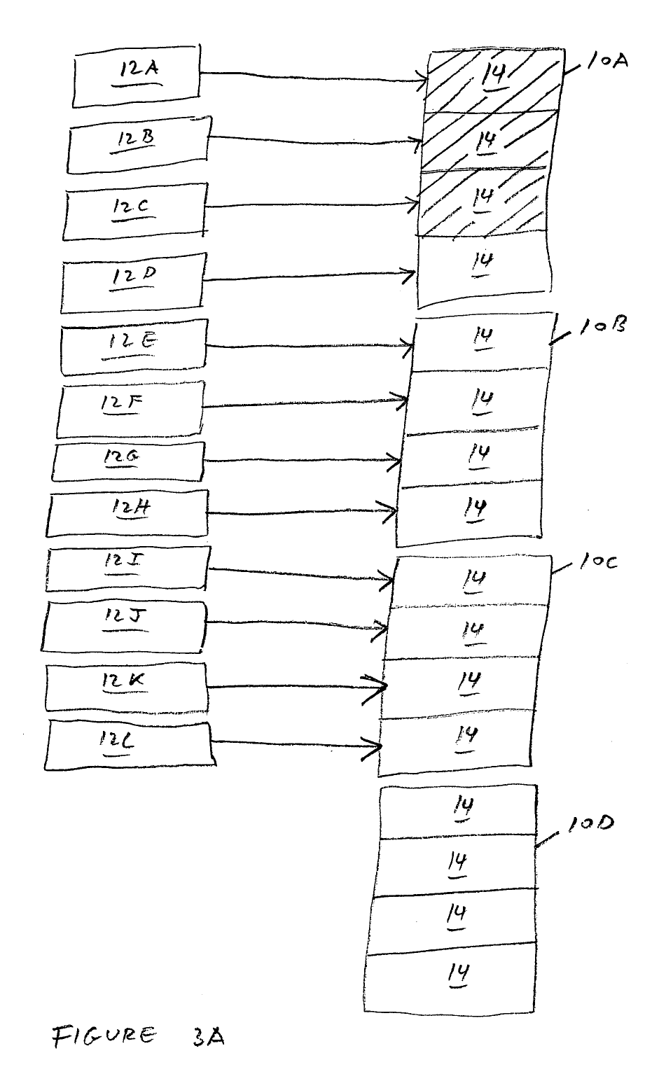

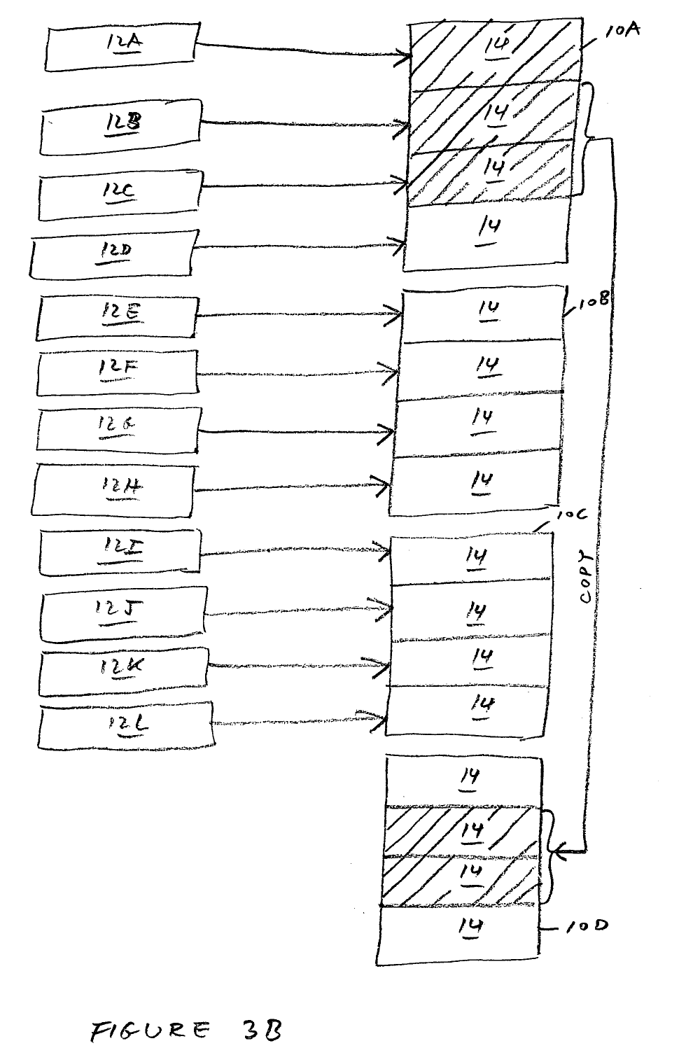

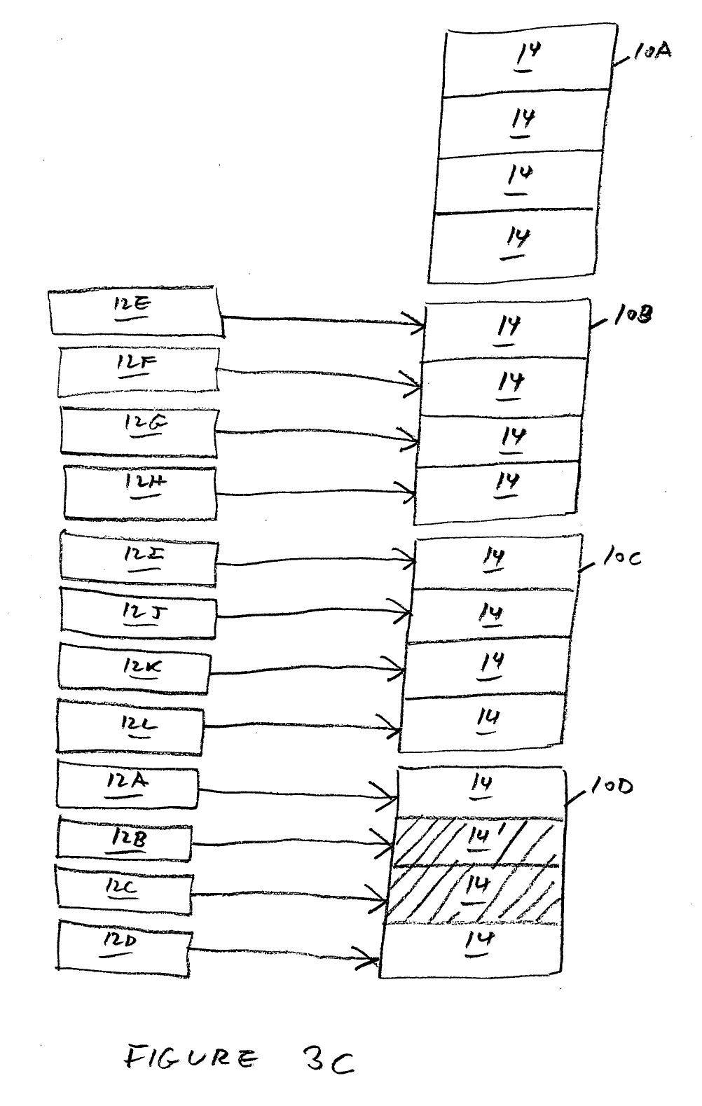

FIGS. 3A through 3C illustrate the second algorithm of the present invention. In this algorithm, the association of pseudo-blocks 12 with virtual blocks 14 is a logical association, indicated in FIGS. 3A through 3C by arrows.

FIG. 3A shows the initial condition of the memory, with valid data written to the virtual blocks 14 corresponding to pseudo-blocks 12A, 12B and 12C indicated by shading. The virtual block 14 that corresponds to pseudo-block 12D is blank.

The host issues a command to erase pseudo-block 12A. As shown in FIG. 2B, the other virtual blocks 14 of physical block 10A that contain valid data, i.e., the virtual blocks 14 that correspond to pseudo-blocks 12B and 12C, are copied to corresponding virtual blocks 14 in spare physical block 10D. The virtual block 14 that corresponds to pseudo-block 12D, being blank, is not copied. Then, physical block 10A is erased and pseudo-blocks 12A through 12D are associated logically with corresponding virtual blocks 14 in physical block 10D, as illustrated in FIG. 3C. Pseudo-block 12B is logically associated with the virtual block 14 to which the data of pseudo-block 12B was copied. Pseudo-block 12C is logically associated with the virtual block 14 to which the data of pseudo-block 12C was copied. Pseudo-blocks 12A and 12D are logically associated with blank virtual blocks 14. Physical block 10A replaces physical block 10D as the spare physical block.

### Third Algorithm

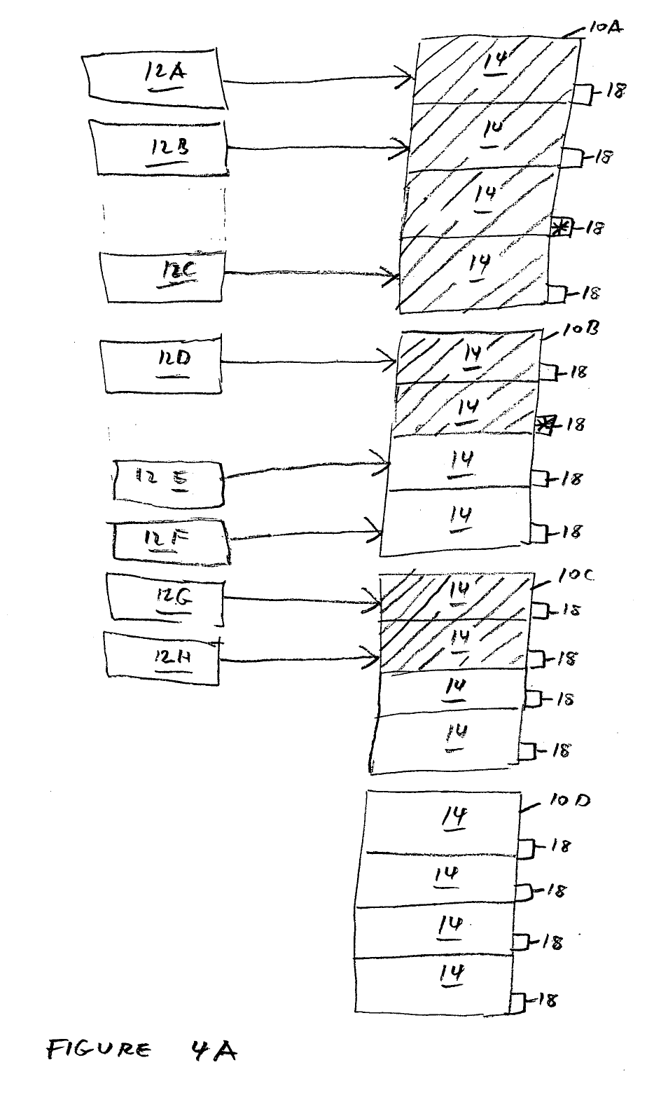

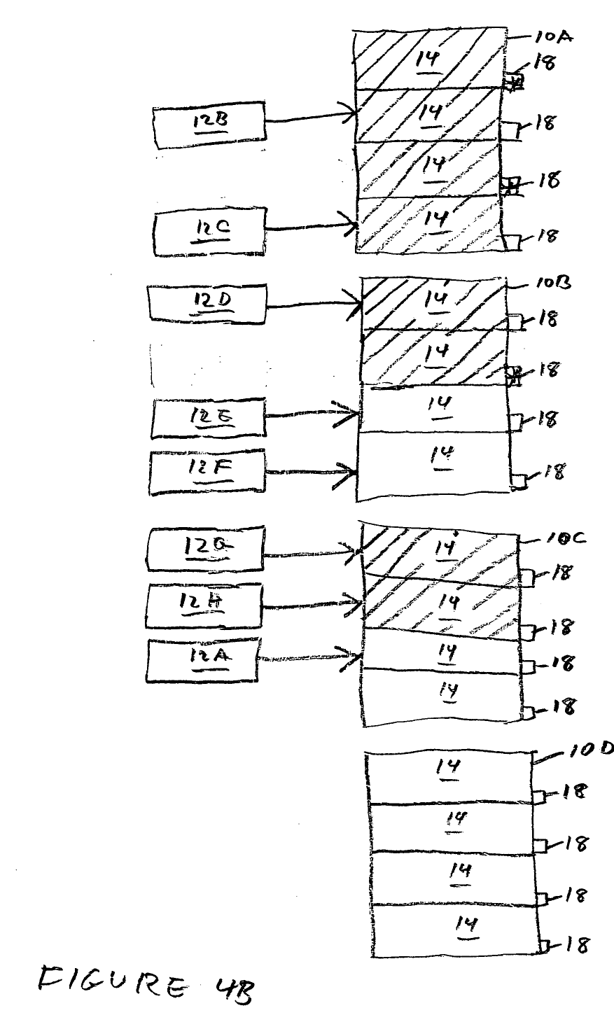

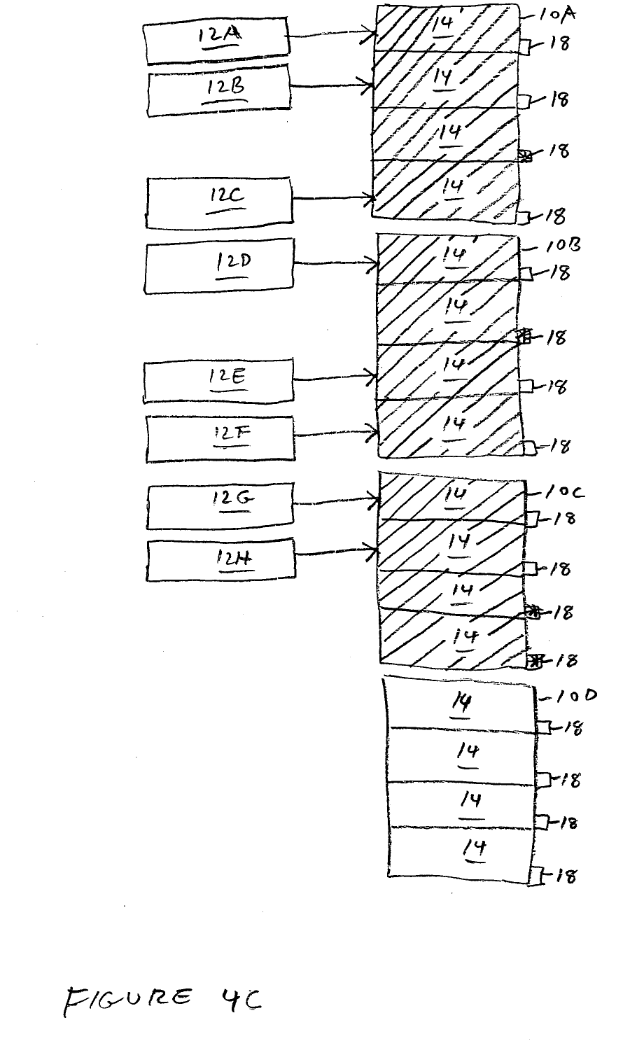

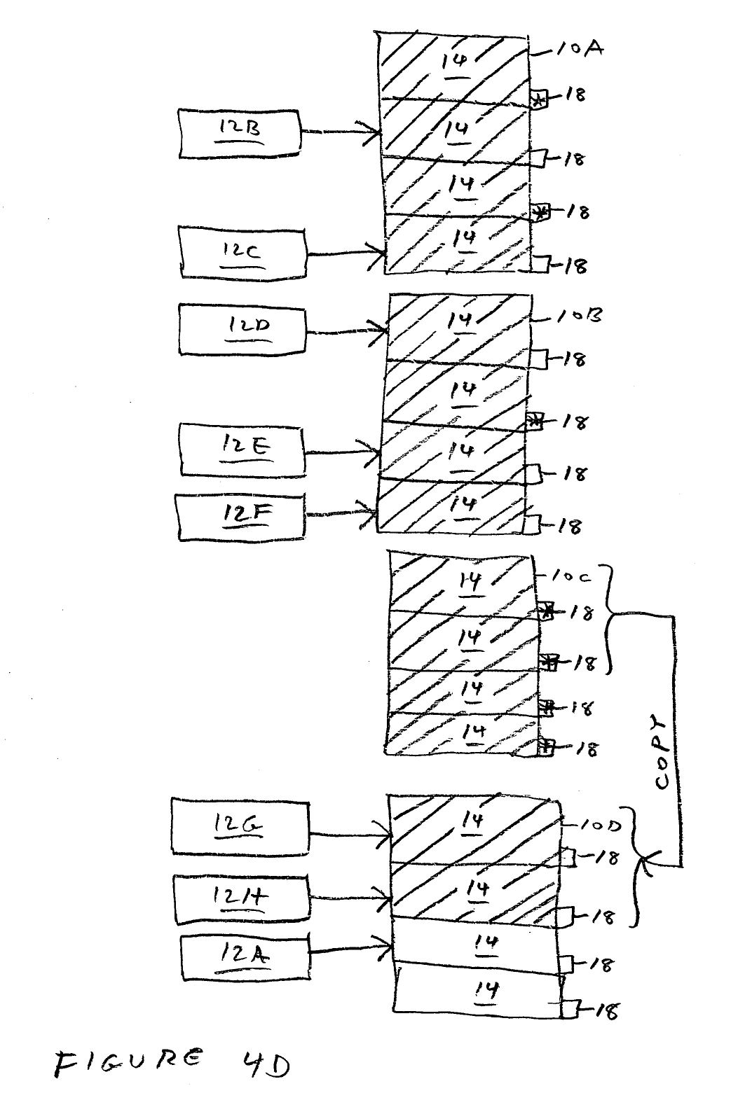

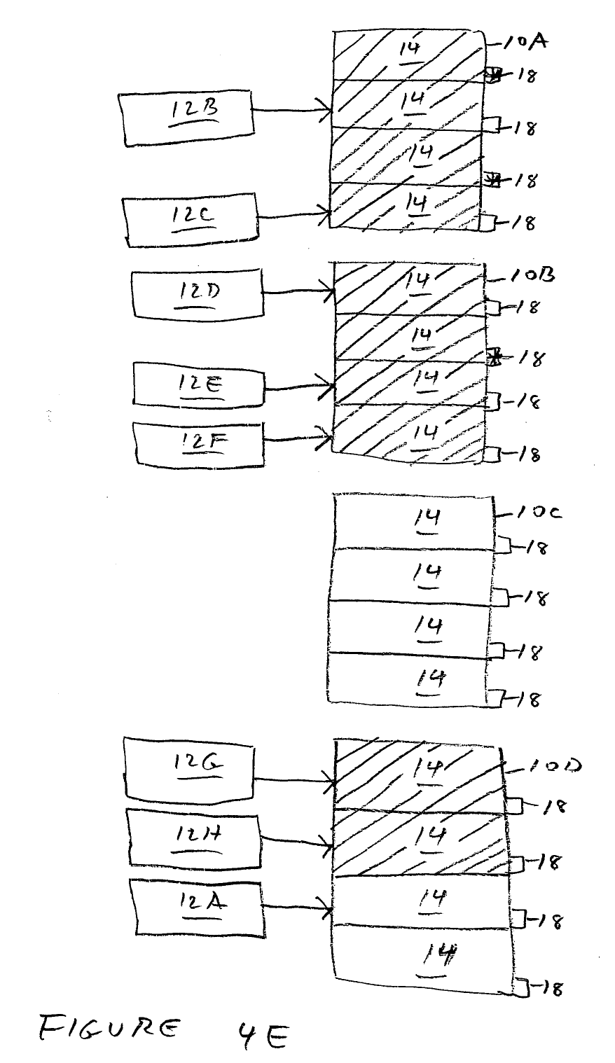

FIGS. 4A through 4E illustrate the third algorithm of the present invention. In this algorithm, the association of pseudo-blocks 12 with virtual blocks 14 is a logical association, indicated in FIGS. 4A through 4E by arrows. Note that in the examples used to illustrate the third algorithm, even some virtual blocks 14 that are not part of the spare physical block 10 do not have corresponding pseudo-blocks 12.

FIG. 4A shows the initial condition of the memory. The virtual blocks 14 corresponding to pseudo-blocks 12A-12D, 12G and 12H contain valid data. Two other virtual blocks 14 contain invalid data and lack corresponding pseudo-blocks 12. That these data are invalid is indicated by appropriate flags in spare cells 18 of these virtual blocks. These flags are represented by asterisks in FIG. 4A. The virtual blocks 14 corresponding to pseudo-blocks 12E and 12F are blank, i.e., in an erased state.

The host issues a command to erase pseudo-block 12A. As shown in FIG. 4B, the controller of the memory seeks, and finds in physical block 10C, a blank virtual block 14 that lacks a corresponding pseudo-block 12. The controller changes the logical association of pseudo-block 12A to this virtual block 14 and flags the data in the virtual block 14 formerly logically associated with pseudo-block 12A as invalid. The virtual block 14 now logically associated with pseudo-block 12A is available for writing new valid data.

FIG. 4C shows an initial condition of the memory in which only the virtual blocks 14 in spare physical block 10D are blank. Only virtual blocks 14 that contain valid data are logically associated with pseudo-blocks 12.

The host issues a command to erase pseudo-block 12A. The controller of the memory, upon failing to find a blank virtual block 14 that lacks a corresponding pseudo-block 12, seeks a good candidate physical block 10 for erasure. A good candidate physical block 10 for erasure is a physical block 10 with a relatively large number of virtual blocks 14 that contain invalid data. In this case, the best candidate physical block 10 for erasure is physical block 10C that has two virtual blocks 14 with invalid data, vs. only one such virtual block 14 in each of physical blocks 10A and 10B. As shown in FIG. 4D, the controller copies the valid data of physical block 10C, i.e., the data in the virtual blocks 14 that are logically associated with pseudo-blocks 12G and 12H, to spare physical block 10D, changes the logical association of pseudo-blocks 12G and 12H to the virtual blocks 14 of physical block 10D to which these valid data have been copied, flags all the data of physical block 10C as invalid, changes the logical association of pseudo-block 12A to a blank virtual block of spare physical block 10D, and flags the data in the virtual block 14 formerly logically associated with pseudo-block 12A as invalid. The virtual block 14 now logically associated with pseudo-block 12A is available for writing new valid data. Finally, as shown in FIG. 4E, the controller erases physical block 10C, thereby replacing physical block 10D with physical block 10C as the spare physical block 10.

FIG. 5 is a high-level block diagram of a flash memory device 110 of the present invention. FIG. 5 is based on FIG. 1 of U.S. Pat. No. 5,404,485, to Ban, which patent is incorporated by reference for all purposes as if fully set forth herein. Device 110 includes a NAND flash memory 112, two flash memory controllers 114 and 118 and a RAM 116. Controller 114 manages memory 112 as taught in U.S. Pat. No. 5,404,485 and in U.S. Pat. No. 5,937,425, also to Ban, which patent also is incorporated by reference for all purposes as if fully set forth herein. (U.S. Pat. No. 5,404,485 applies to the management of flash memories generally. U.S. Pat. No. 5,937,425 is specific to NAND flash memories.) Controller 114 exchanges data stored in memory 112 with a host device (not shown) in the conventional manner. For example, if device 110 is used for non-volatile data storage in a system such as a personal computer, then controller 114 communicates with the other components of the system via the system's bus. If device 110 is a portable storage device that is reversibly attached to a host using a suitable interface, for example the USB interface taught in U.S. Pat. No. 6,148,354, to Ban et al., then controller 114 communicates with the host via that interface.

Controller 114 was originally intended for use with a NAND flash memory that has a smaller erase block size than does memory 112. Therefore, controller 118 is interposed between controller 114 and memory 112. Controller 118 therefore presents memory 112 to controller 114 as though the erase block size of memory 112 were the smaller erase block size that controller 114 expects, as described above.

Device 110 is an example of a firmware implementation of the method of the present invention. FIG. 6 is a partial high-level block diagram of a computer system 120 of the present invention that is an example of a software implementation of the method of the present invention. System 120 includes a processor 122; a RAM 124; input and output devices such as a keyboard and a display screen, represented collectively by I/O block 132; and two non-volatile mass storage memories: a hard disk 126 and a NAND flash memory 130. Components 122, 124, 126, 130 and 132 communicate with each other via a common bus 134. Among the data stored on hard disk 126 is the code of an operating system 128. When system 120 is powered up, processor 122 downloads the code of operating system 128 to RAM 124 and then executes the code of operating system 128 from RAM 124 to manage the operation of system 120. Hard disk 126 thus is an example of a computer-readable storage medium in which is embedded computer-readable code for implementing the method of the present invention.

The code of operating system 128 includes code for managing NAND flash memory 130 as taught in U.S. Pat. No. 5,404,485 and in U.S. Pat. No. 5,937,425. The code of operating system 128 also includes code for managing NAND flash memory 130 according to the principles of the present invention as described above. The prior art portion of the NAND flash management code was originally installed to manage a different NAND flash memory, with a smaller erase block size than the erase block size of NAND flash memory 130. Now, though, NAND flash memory 130 has been substituted for the NAND flash memory that originally was installed in system 120. The present invention portion of the NAND flash management code therefore presents NAND flash memory 130 to the prior art portion of the NAND flash management code as though the erase block size of NAND flash memory 130 were the smaller erase block size of the NAND flash memory that originally was installed in system 120.

While the invention has been described with respect to a limited number of embodiments, it will be appreciated that many variations, modifications and other applications of the invention may be made.

What is claimed is:

1. A method of managing a memory, comprising the steps of:
(a) structuring the memory as a plurality of physical blocks having a certain size, the memory being erased in units of said physical blocks; and
(b) presenting the memory as though the memory is erased in units of pseudo-blocks that are smaller in size than said physical blocks.

2. The method of claim 1, wherein said size of said physical blocks is an integral multiple of said size of said pseudo-blocks.

3. The method of claim 1, wherein said presenting is effected by steps including:
(i) designating one of said physical blocks as a spare physical block;
(ii) storing data associated with one of the pseudo-blocks in another one of the physical blocks; and
(iii) upon receiving a command to erase said one pseudo-block:
(A) copying all valid contents of said other physical block, except for said data, to said spare physical block, and
(B) erasing said other one physical block.

4. The method of claim 3, wherein said presenting is effected by steps including: upon receiving said command to erase said one pseudo-block:
(C) subsequent to said erasing of said other physical block, copying all valid contents of said spare physical block to said other one physical block; and
(D) subsequent to said copying of all valid contents of said spare physical block to said other one physical block, erasing said spare physical block.

5. The method of claim 3, wherein said presenting is effected by steps including: upon receiving said command to erase said one pseudo-block:
(C) subsequent to said erasing of said other one physical block, substituting said other one physical block for said spare physical block.

6. The method of claim 1, wherein said presenting is effected by steps including:
(i) designating one of said physical blocks as a spare physical block;
(ii) logically associating one of the pseudo-blocks with a first virtual block in a first one of the physical blocks other than said spare physical block; and
(iii) upon receiving a command to erase said one pseudo-block:
(A) marking said first virtual block as logically erased, and
(B) seeking a physically erased virtual block in the memory.

7. The method of claim 6, wherein said presenting is effected by steps including: upon receiving said command to erase said one pseudo-block:
(C) if said seeking finds said physically erased virtual block: logically associating said one pseudo-block with said physically erased virtual block;
(D) otherwise:
(I) copying only a portion of a second physical block, other than said spare physical block, to said spare physical block, said copying leaving at least one virtual block of said spare physical block in a physically erased state,
(II) subsequent to said copying, logically associating said one pseudo-block with one of said at least one physically erased virtual blocks of said spare physical block,
(III) erasing said second physical block, and
(IV) substituting said second physical block for said spare physical block.

8. The method of claim 7, wherein said first and second physical blocks are identical.

9. The method of claim 7, wherein said first and second physical blocks are different.

10. A memory device comprising:
(a) a memory that includes a plurality of physical blocks having a certain size; and
(b) a controller for:
(i) erasing said memory in units of said physical blocks, and
(ii) presenting the memory as though said memory is erased in units of pseudo-blocks that are smaller in size than said physical blocks.

11. The memory device of claim 10, wherein said memory is a flash memory.

12. A computer-readable storage medium having computer-readable code embedded on the computer-readable storage medium, the computer-readable code for managing a memory that includes a plurality of physical blocks having a certain size, the computer-readable code comprising:
(a) program code for erasing said memory in units of said physical blocks; and
(b) program code for presenting the memory as though the memory is erased in units of pseudo-blocks that are smaller in size than said physical blocks.
